(19) United States
(12) Patent Application Publication
(10) Pub. No.: US 2002/0030627 A1
(43) Pub. Date: Mar. 14, 2002

(54) ANTENNA FOR A RADIO COMMUNICATIONS APPARATUS

(76) Inventor: ERLAND CASSEL, DJURSHOLM (SE)

Correspondence Address: SMITH GAMBRELL & RUSSELL, BEVERIDGE DEGRANDI WEILACHER & YOUNG, 1850 M STREET NW, SUITE 800, WASHINGTON, DC, 20036

(21) Appl. No.: 09/403,863

(22) PCT Filed: Apr. 27, 1998
(86) PCT No.: PCT/SE98/00764

(30) Foreign Application Priority Data
Apr. 30, 1997 (SE) 9701646-3

(51) Int. Cl. H01Q 1/24; H01Q 1/36

(52) U.S. Cl. 343/702; 343/895

(57) ABSTRACT

The disclosure relates to an antenna. To improve transmission and reception in a mobile telephone, it has a so-called diversity antenna. The invention relates to an antenna (4) suitable as a diversity antenna. The antenna (4) has a plate (20) of insulating material with a foil coating (10, 22) on both sides. In the foil (10, 22) there are provided two slots (7, 23) one on each side. The slots (7, 23) have meander formations or windings in order that their electric length exceed their physical length. The one slot (23) is 1-3% longer than the other. At one closed end (12) of the one slot (7), there are connections (13, 14) for a supply line. The foil coatings (10, 22) are in contact with one another through a plate (18) which is soldered fast on the side of the carrier (20) at right angles thereto. Laterally in relation to the longitudinal direction of the slots (7, 23) there is an earth plane (6). The foil coatings (10, 22) extend out on this and both sides are in galvanic communication (27) with one another. In order to increase the electric length of the earth plane (6), slots (15) are provided in the foil coatings (10, 22).

### TECHNICAL FIELD

The present invention relates to an antenna for a radio communications apparatus operating in the frequency range of 800 MHz-3 GHz and including a slot provided in a metallic conductor.

### BACKGROUND ART

In the employment of mobile radio communications apparatuses, in daily parlance mobile telephones in an urban environment, problems are often encountered in transmission and receiving. The reason for this is that, in such an environment, there are often dead zones which cannot be reached in communication with a certain cell in the system.

In order to remedy this problem, use is often made of duplicated antennae in mobile telephones, these antennae having different directive effect, polarisation and/or appearance on the antenna lobe. Such a second antenna is often entitled a diversity antenna.

### PROBLEM STRUCTURE

The present invention has for its object to design the antenna intimated by way of introduction such that this will be suitable for use as a diversity antenna. Thus, the present invention has for its object to design the antenna in such a way that it will have a directive effect, good efficiency and, above all, extremely small dimensions so that it may be incorporated entirely into an apparatus casing. Finally, the present invention has for its object to realise an antenna which is of wide band operation.

### SOLUTION

The objects forming the basis of the present invention will be attained if the antenna intimated by way of introduction is characterized in that the slot has windings or meander formations disposed in one plane.

As a result of this feature, advantages will be afforded such as directive effect and extremely small integration dimensions.

Suitably, the antenna is also characterized in that it includes two slots disposed in substantially parallel planes, both having windings or meander formations and in which the one slot is of slightly greater length than the other.

As a consequence of these characterizing features, advantages will be afforded such as increased sensitivity and wide band capability despite the fact that the physical integration dimensions are hardly affected.

Further advantages will be attained according to the present invention is the antenna is also given one or more of the characterizing features as set forth in appended claims 4 to 14.

### BRIEF DESCRIPTION OF THE ACCOMPANYING DRAWINGS

The present invention will now be described in greater detail hereinbelow, with reference to the accompanying Drawings. In the accompanying Drawings:

FIG. 1 is a rear view of a cut open mobile telephone which is provided with a diversity antenna according to the invention;

FIG. 2 shows the antenna of FIG. 1 on a larger scale;

FIG. 3 is a view of the antenna of FIG. 2 seen from beneath in FIG. 2;

FIG. 4 is a view of the antenna of FIG. 2 seen from the right in FIG. 2;

FIG. 5 is a circuit card for producing the antenna seen from the rear side according to FIG. 2; and

FIG. 6 shows the circuit card according to FIG. 5 seen from the front according to FIG. 2.

### DESCRIPTION OF PREFERRED EMBODIMENT

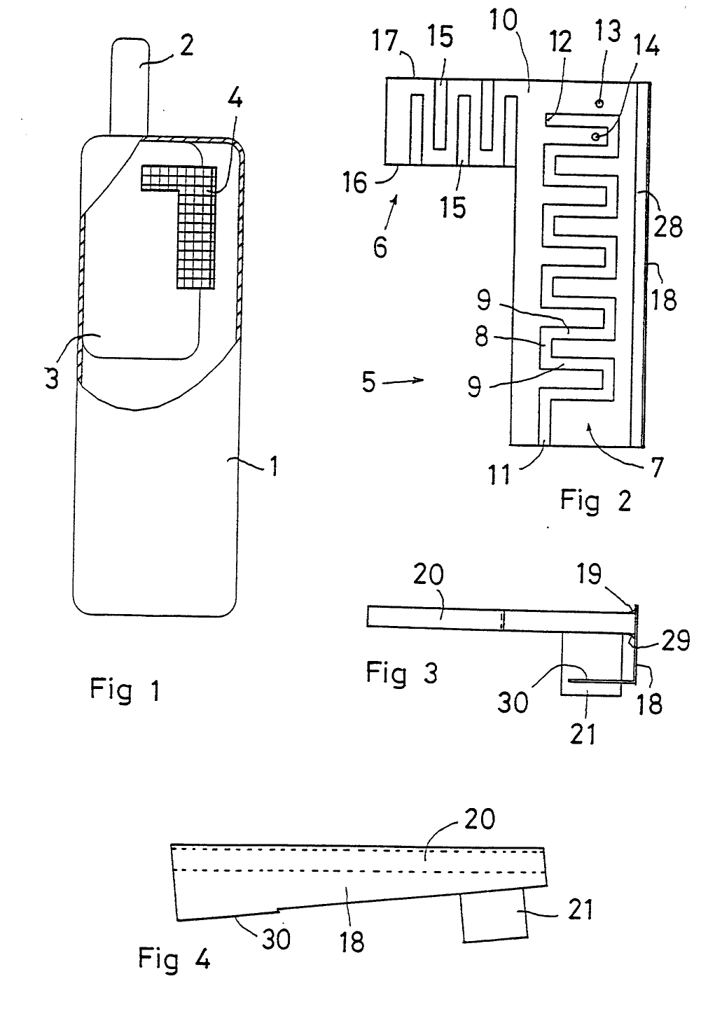

In FIG. 1, reference numeral 1 relates to the outer hood or casing of a mobile telephone which has an outer antenna 2. The mobile telephone according to FIG. 1 is seen from the rear side, i.e. that side which faces away from the key cluster etc. It will be further apparent from the figure that, interiorly in the mobile telephone, there is a screen can 3 which houses the electronics included in the telephone. Furthermore, there is mounted in connection with the screen can a diversity antenna 4. The antenna 4 has only been shown in respect of its outer contours and physical location.

The antenna 4 is a so-called F-antenna (often called Notch antenna, slot antenna or slit antenna) and includes a metallic conductor 10 with a radiating slot.

In the view illustrated in FIG. 2, the antenna 4 is in the form of an inverted L which is composed of a larger rectangular part 5 and a smaller rectangular part 6. The larger rectangular part 5 contains the antenna proper, while the smaller rectangular part 6 contains an earth plane for the antenna. The conductor 10 around the slot also functions as an earth plane.

The antenna according to FIG. 2 has, on the side facing towards the observer, a metal foil 10 in which grooves or slots are provided. In the larger part 5, the antenna 4 has a continuous slot 7 which is the radiating portion of the antenna. In order to reduce the space requirements, the slot 7 is designed with windings or meander formations. On the Drawing, shorter slot portions 8 are shown which are substantially at right angles in relation to the longer slot portions 9. The windings or meander formations lie in a common plane which corresponds to the plane of extent of the foil-shaped metallic conductor 10 in which the slot 7 is accommodated. Given that the slot has windings or meander formations, it will have an electric length which is considerably greater than its physical length. If, in addition, the slot is filled with plastic, the electric length will be even greater in relation to the physical length. An antenna of this type also has a certain directive effect.

In FIG. 2, the antenna is designed as a quarter wave antenna where the one end 11 of the slot 7 is open. The opposite end 12 of the slot 7 is closed. In the proximity of the closed end 12, there are provided connections 13, 14 for supply to the antenna.

If the antenna 4 is to be designed as a half wave antenna, the slot 7 is made correspondingly longer and its end 11 is to be closed.

The foil-shaped conductor 10 extends out on the smaller rectangular part 6 of the antenna and there forms an earth plane. In order to increase the electrical size of the earth plane, this is also provided with alternatingly disposed slots 15 which have their one end open towards opposing edges 16 and 17 of the smaller rectangular part 6.

Along the right-hand edge of the larger rectangular part 5 in FIG. 2, there is disposed an elongate plate 18 which, via a solder 19, is connected to the metallic conductor 10 on the front side of the antenna in FIG. 2. As a result, the plate 18 is in galvanic communication with the foil-shaped conductor throughout the entire length of the plate.

The plane of extent of the plate 18 is transversely directed, but also preferably at right angles, to the plane of extent of the foil-shaped conductor 10. This is clearly apparent from FIG. 3. Further, the plate 18 is, throughout its entire length, of greater width than the thickness of the carrier 20 of insulating, non-magnetic material which is employed for supporting the metallic conductor 10. The plate 18 also functions as an amplifier of the earth plane of the antenna.

It is further apparent from FIG. 3 that there is disposed, on the rear side of the antenna 4 in FIG. 2, a terminal 21 for connecting a supply line. Solder pins in the terminal 21 extend through the carrier 20 and are visible on the front side of the antenna in FIG. 2 at the connections 13 and 14, but not however forming a galvanic communication with the foil-shaped conductor 10 on the front side of the antenna.

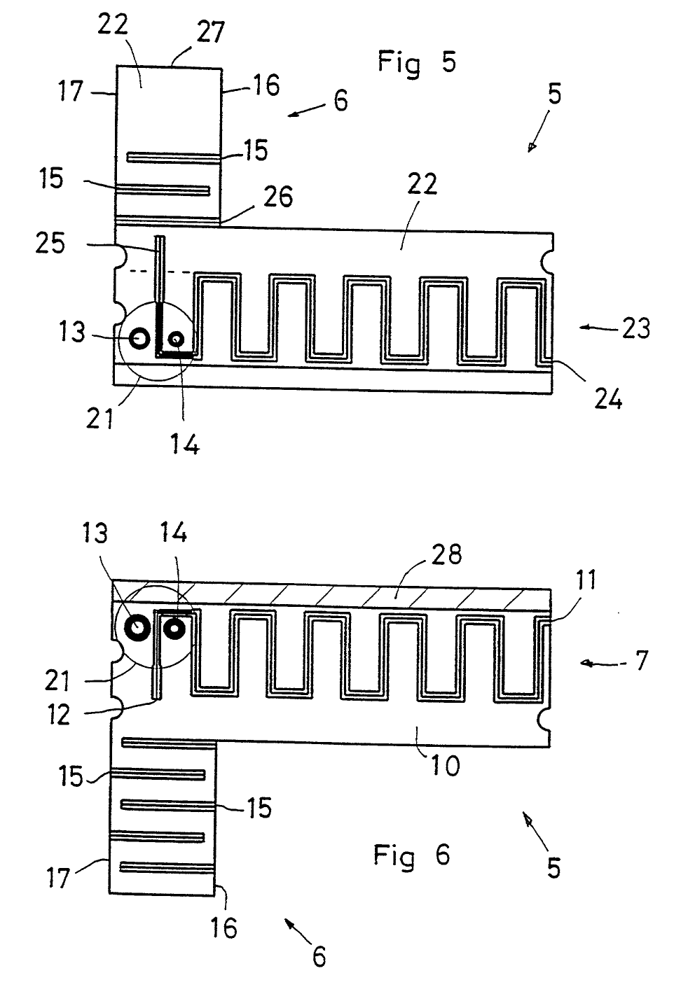

It will be apparent from FIGS. 5 and 6 that the carrier 20 also has on its rear side (the side facing away from the observer in FIG. 2) a foil-shaped, metallic conductor 22 with a slot 23. This slot also has an open end 24. The slots 7 and 23 follow one another throughout the greater part of their extent, but the slot 23 on the rear side of the antenna is, at its supply end, slightly longer than the slot 7 on the front side of the antenna. Thus, the slot 23 has an extension 25 in relation to that which applies to the slot 7.

That the slots 7 and 23 are of different lengths in this manner implies that they will be set for different resonance frequencies. As a result, there will be realised an antenna which, seen as a whole, is more wide band capable than the individual slots 7 and 23 would be separately.

It will further be apparent from FIG. 5 that the foil-shaped conductor 22 on the smaller rectangular part 6 is discrete, via a slot 26, from the major portion of the conductor which defines the slot 23. Further, there are, in the smaller rectangular part 6, counterparts to the slots 15 on the front side of the antenna. At the outer end edge 27 of the smaller rectangular part 6, both of the metallic conductors 22 and 10 are interconnected with one another via a plating or other thin metallic layer (not shown in the Figure).

The circuit card from which the antenna 4 is produced has, after provision of the slots, 15 and 23, been provided with a protective paint coating which can form the above-mentioned plastic filing of the slots. However, along the one longitudinal edge of the larger rectangular part 5, there is provided an uninsulated strip 28 on either side of the carrier 20. These uninsulated strips 28 permit production of the solder joint 19 (see FIG. 3) and a corresponding solder joint 29 on the rear side of the antenna.

As was mentioned above, at the terminal 21 there is only galvanic contact with the metallic conductor 22 on the rear side of the antenna while, on the other hand, no such galvanic contact exists with the metallic conductor 10 on the front side of the antenna.

It will be apparent from FIGS. 3 and 4 taken together that the plate 18 has a tongue 30 which only extends along a part of the length of the plate 18 but which is bent in on the underside of the carrier 20 and a distance from it. The tongue 30 constitutes an impedance adaptation between the antenna and its earth plane.

In one embodiment of the antenna 4 dimensioned for the 800 MHz band, the larger rectangular part 5 is dimensioned 31×11.2 mm. The smaller rectangular part 6 is dimensioned 11.2×7.4 mm.

The two slots 7 and 23 have a centre distance of approx. 3 mm between the long portions 9 of the slots, while the distances between the shorter portions 8 of the slots amount to approx. 3 mm.

The centre distances between the slots 15 is approx. 1.5 mm and their length amounts to approx. 6 mm.

The thickness of the carrier is approx. 1.6 mm while the width of the plate 18 in its narrower end (see FIG. 4) is 3.9 mm, while its cuneiform configuration amounts to 6.5°.

The length of the extension 25 is the slot 23 is such that the slot 23 is 1-3% longer than the slot 7.

### DESCRIPTION OF ALTERNATIVE EMBODIMENTS

On the Drawings, the slots 7 and 23 are shown with meander formations in right angles and with “rectangular form”. However, according to the present invention other embodiments of the meander formations are conceivable where, for example, the shorter portions 8 of the slots may be replaced by curved arcs. Furthermore, the meander formations may be “quadratic” or designed as serrations. On the other hand, it has proved that a pure sinusoidal form of the meander formations does not function well in practice.

The present invention may be further modified without departing from the scope of the appended Claims.

What is claimed is:

1. An antenna for a radio communications apparatus operating in the frequency range of 800 MHz-3 GHz and including a slot (7, 23) provided in a metallic conductor (10, 22), characterized in that the slot (7, 23) has windings or meander formations disposed in one plane.

2. The antenna as claimed in claim 1, characterized in that it includes two slots (7, 23) disposed in substantially parallel planes and both having windings or meander formations.

3. The antenna as claimed in claim 2, characterized in that the one slot (23) is of slightly greater length than the other (7).

4. The antenna as claimed in claim 3, characterized in that the length difference between the slots (7, 23) amounts to approx. 1-3%.

5. The antenna as claimed in any of claims 2 to 4, characterized in that the slots (7, 23) are located each in their foil-shaped metallic conductor (10, 22, respectively), said conductors being disposed on opposite sides of a panel (20) of insulating, non-magnetic material.

6. The antenna as claimed in claim 5, characterized in that the foil-shaped conductors (19, 22) are in galvanic communication (18, 19, 29; 27) with each other.

7. The antenna as claimed in any of claims 2 to 6, characterized in that the slots (7, 23) each have a total electric length of the order of magnitude of one quarter of a wavelength, the one ends (11, 24) of the slots being open while the opposite ends are closed, and one of the slots having, at the closed end, a connection (21) for a supply line.

8. The antenna as claimed in any of claims 2 to 6, characterized in that the slots (7, 23) each have a total electric length of the order of magnitude of one half of a wavelength, the slots having both of their ends closed, and one of the slots having at its one end, a connection (21) for a supply line.

9. The antenna as claimed in any of claims 1 to 8, characterized in that the antenna (4) includes an earth plane (6) disposed in the metallic conductor (10, 22).

10. The antenna as claimed in claim 9, characterized in that the earth plane extends, with one part (6) out laterally in relation to the longitudinal direction of the slots (7, 23).

11. The antenna as claimed in any of claims 5 to 10, characterized in that the laterally projecting part (6) of the earth plane includes portions of both of the foil-shaped conductors (10, 22), these being, within the region of the projecting part, in galvanic communication (27) with one another.

12. The antenna as claimed in any of claims 5 to 11, characterized in that the projecting part (6) of the earth plane is of greater electric length than physical length in that the foil-shaped conductors (10, 22) have slots disposed alternatingly from opposing edges.

13. The antenna as claimed in any of claims 5 to 12, characterized in that the foil-shaped conductors (10, 22) are in galvanic communication with one another via a plate (18) whose longitudinal direction is substantially parallel with the longitudinal direction of the slots (23) and whose width is transversely directed in relation to the plane of extent of the foil-shaped conductors.

14. The antenna as claimed in claim 13, characterized in that the width of the plate (18) is greater than the distance between the foil-shaped conductors (10, 22), whereby the plate (18) extends with at least one edge region outside the adjacent foil-shaped conductor (22).
